(19) United States
(12) Patent Application Publication
(10) Pub. No.: US 2003/0145082 A1
(43) Pub. Date: Jul. 31, 2003

(54) NAT device with LAN monitor for remote management

(76) Inventor: Yong Ho Son, Sunnyvale, CA (US)

Correspondence Address: OKAMOTO & BENEDICTO, LLP, P.O. BOX 641330, SAN JOSE, CA, 95164, US

(21) Appl. No.: 10/146,478

(22) Filed: May 15, 2002

Related U.S. Application Data
(60) Provisional application No. 60/351,402, filed on Jan. 25, 2002.
(60) Provisional application No. 60/377,703, filed on May 3, 2002.

(51) Int. Cl. G06F 15/16

(52) U.S. Cl. 709/224; 709/225; 709/249

(57) ABSTRACT

One embodiment of the invention is a network address translation enabled router device (NAT device) for separating a small office/home office local area network (SOHO LAN) from a wide area network (WAN). The NAT device includes a SOHO LAN monitor system. The SOHO LAN monitor system includes a query engine for sending queries to monitoring agents in hosts on the LAN, a data collection engine for receiving and collecting monitored data from the monitoring agents, and an access controller for controlling access to the SOHO LAN monitor system on the NAT device.

### CROSS-REFERENCE TO RELATED APPLICATIONS

The present application claims the benefit of U.S. patent application Ser. No. 60/351,402, filed Jan. 25, 2002, entitled “NAT device to collect, monitor, and periodically update the SOHO LAN provisioning, performance, and status,” by inventor Yong Ho Son. The present application also claims the benefit of U.S. patent application Ser. No. 60/377,703, filed May 3, 2002, entitled “NAT Device with LAN Monitor for Remote Management,” by inventor Yong Ho Son.

### BACKGROUND OF THE INVENTION

1. Field of the Invention

The present invention relates generally to computer networks. More particularly, the invention relates to monitoring and management of local area networks.

2. Description of the Background Art

### BRIEF DESCRIPTION OF THE DRAWINGS

Non-limiting and non-exhaustive embodiments of the present invention are described in the Figures, in which:

FIG. 1 is a diagram depicting a network address translation router device (NAT device) between a wide area network (WAN) and a local area network (LAN).

FIG. 2 is a diagram depicting a NAT device in accordance with an embodiment of the invention.

FIG. 3 is a diagram depicting a host device that is coupled to the LAN in accordance with an embodiment of the invention.

FIG. 4 is a diagram depicting a system for monitoring a plurality of LANs by way of NAT devices in accordance with an embodiment of the invention.

FIG. 5 is a flow chart depicting a method for remotely monitoring a LAN in accordance with an embodiment of the invention.

FIG. 6 is a diagram depicting contents of monitored data storage in the NAT device in accordance with an embodiment of the invention.

### SUMMARY

One embodiment of the invention is a network address translation enabled router device (NAT device) for separating a small office/home office local area network (SOHO LAN) from a wide area network (WAN). The NAT device includes a SOHO LAN monitor system. The SOHO LAN monitor system includes a query engine for sending queries to monitoring agents in hosts on the LAN, a data collection engine for receiving and collecting monitored data from the monitoring agents, and an access controller for controlling access to the SOHO LAN monitor system on the NAT device.

Another embodiment of the invention is a system for monitoring a plurality of local area networks (LANs) by way of network address translation enabled router devices (NAT devices) between the LANs and a wide area network (WAN). The system comprises monitoring agents for hosts on each of the LANs and a plurality of NAT devices. Each NAT device is located between a LAN and the WAN. Each NAT device includes a query engine for sending queries to the monitoring agents on the corresponding LAN, a data collection engine for receiving and collecting monitored data from the monitoring agents on the corresponding LAN, and an access controller for controlling access to the NAT device. The system also includes a central controller system coupled to the WAN for accessing and retrieving the monitored data from the plurality of NAT devices.

A further embodiment of the invention is a method for remotely monitoring a local area network (LAN) by way of a monitor system on a network address translation (NAT) device. The method includes sending queries to monitoring agents in hosts on the LAN, receiving data returned from the monitoring agents, and providing secure remote access by a data service provider to the monitor system. This embodiment defines a Virtual SOHO Node for scalability. From a cardinality perspective, the number of devices that are remotely managed, by aggregating all the LAN devices under the Virtual SOHO Node of a single NAT device, is of value from health and fault monitoring perspective. A single Virtual SOHO Node is managed as Healthy or Faulted. By querying the NAT device, additional information of what device on the LAN has faulted can be realized. Hence from Remote Management perspective, managing 10,000 SOHO LANs become managing 10,000 Virtual SOHO Nodes. Without this aggregation into Virtual SOHO Nodes, managing 10,000 SOHO LANs could be at least managing 50,000 different networked devices (if on the average that are 5 Network devices per SOHO LAN—e.g. Cable Modem, 2 or more PCs, NAT device, and a Networked Printer).

### DETAILED DESCRIPTION

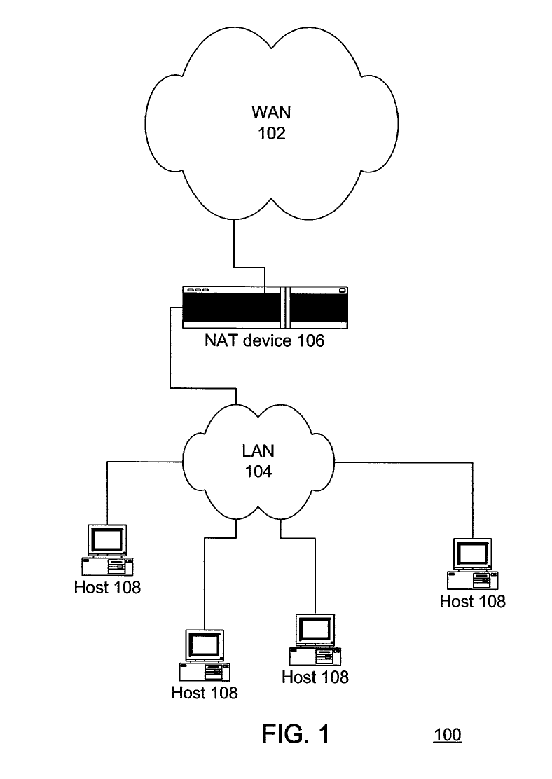

FIG. 1 is a diagram depicting a network address translation router device (NAT device) between a wide area network (WAN) and a local area network (LAN). Depicted in FIG. 1 are a WAN 102, a LAN 104, a NAT device 106, and multiple hosts 108.

The WAN 102 may comprise, for example, a network of a multiple services operator (MSO) or other data service provider. Other data service providers include direct subscriber line (DSL) providers, satellite data service providers, and wireless data service providers. The WAN 102 may also comprise, for example, a network of networks such as the Internet.

The LAN 104 may comprise, for example, a LAN of a small office or of a home office. The LAN 104 may be formed using various forms of cabling or may be wireless. The LAN 104 may utilize various protocols, for example, TCP/IP which is the protocol of the Internet, NetBEUI defined by Microsoft Corporation with corporate offices in Redmond, Wash., and IPX/SPX developed by Novell, Inc. with corporate offices in Provo, Utah.

The LAN 104 interconnects various hosts 108 and provides for communications between the hosts 108. The hosts 108 may comprise personal computers and various other networkable devices. Other networkable devices include networkable printers, networkable scanners, networkable faxes, and so on. The hosts 108 may be coupled to the LAN 104 using network interface cards (NICs) or network adapters, along with associated drivers.

Of particular interest to the present invention, a NAT device 106 may be placed in between the WAN 102 and the LAN 104. The NAT device 106 conventionally translates Internet Protocol (IP) addresses between a private LAN and the public (global) Internet. This conventional function of the NAT device 106 effectively provides transparent routing of IP datagrams between the private address realm of the LAN and the public address realm of the Internet. The NAT device 106 translates addresses in IP headers so that packets can be routed properly as they move between the two address realms.

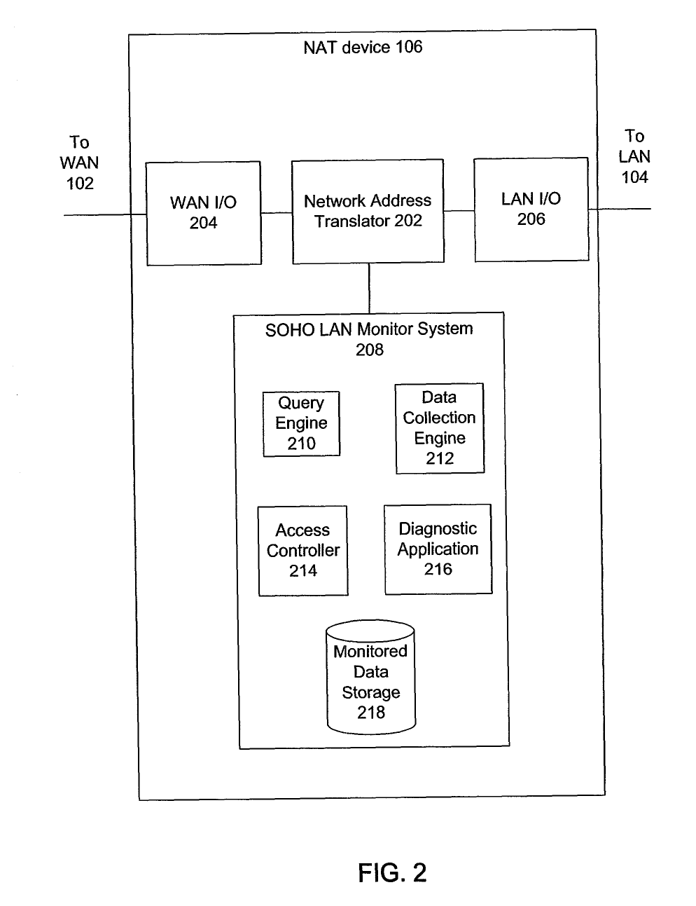

As described below, one embodiment of the present invention adds substantial functionality to the NAT device 106. The functionality added provides for monitoring and remote management of the LAN 104 coupled to the NAT device 106. A NAT device 106 with such added functionality is described further below in relation to FIG. 2.

FIG. 2 is a diagram depicting a NAT device in accordance with an embodiment of the invention. Depicted in FIG. 1 is a NAT device 106 that includes a Network Address Translator 202, a WAN Input/Output (I/O) interface 204, a LAN I/O interface 206, and a SOHO LAN Monitor System 208.

The Network Address Translator 202 provides the conventional IP address translation function described above. The WAN I/O 204 provides an interface between the NAT device 106 and the WAN 102. Similarly, the LAN I/O 206 provides an interface between the NAT device 106 and the LAN 104.

For example, IP packets from the WAN 102 that are destined for hosts 108 on the LAN 104 are received by the WAN I/O 204 and passed to the Translator 202. The Translator 202 applies address bindings (either static or dynamic) to translate the destination IP addresses in the header of the packets from the WAN address realm to the LAN address realm. The IP packets with translated destination addresses are passed on from the Translator 202 to the LAN I/O 206 for transmission to the LAN 104.

One embodiment of the present invention relates to the SOHO LAN Monitor System 208 in the NAT device 106. As depicted in the embodiment illustrated in FIG. 2, the Monitor System 208 may be coupled to the Translator 202 in the NAT device 106. Other embodiments may incorporate the Monitor System 208 into the NAT device 106 using different implementations.

As depicted in FIG. 2, the SOHO LAN monitor system 208 may comprise various components. Such components include a query engine 210, a data collection engine 212, an access controller 214, one or more diagnostic applications 216, and storage 218 to hold monitored data.

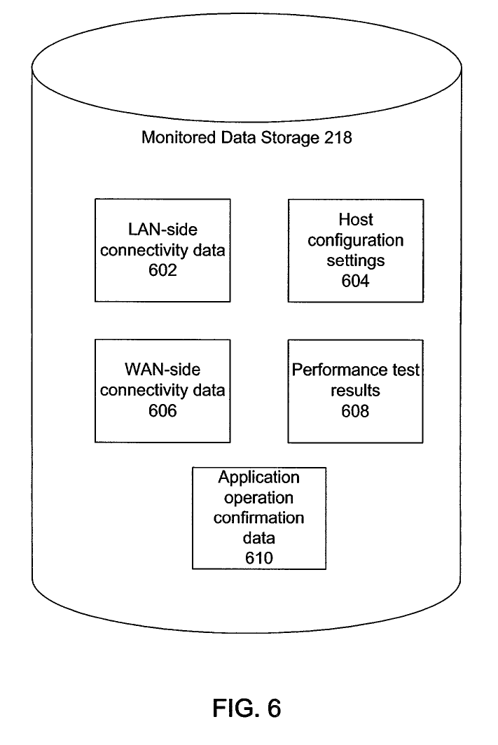

The query engine 210 sends queries from the monitor system 208 to monitoring agents 302 at Hosts 108 on the LAN 104. The data collection engine 212 receives and collects the monitored data returned from the monitoring agents 302 in response to the queries. The access controller 214 controls access to the monitor system 208 on the NAT device 106. The diagnostic application 216 may comprise a remotely-initiated diagnostic application that has routines to diagnose problems on the LAN 104. Such a diagnostic application 216 may be used, for example, by customer support of a data service provider to diagnose problems on a customer's LAN. The monitored data storage 218 provides storage for the monitored data collected by the data collection engine 212. The monitored data storage 218 is described in further detail below in relation to FIG. 6.

In one embodiment, the monitor system 208 is configured to be accessible by way of a specific port. The specific port may be assigned by static association of the port with the monitor system 208. The port may comprise, for example, a TCP (transmission control protocol) port, or a UDP (user datagram protocol) port. Both TCP and UDP are standard layer four (4) protocols that provides for ports to distinguish between requests.

In one embodiment, the access controller 214 may be configured for joint access both by a first party by way of the LAN 104 and by a second party by way of the WAN 102. For example, the first party may be a customer that uses the LAN 104 (more particularly, a network administrator for the LAN 104), and the second party may be a data service provider.

In one embodiment, the access controller 214 may be configured to have multiple levels of access to a set of SOHO LAN monitor settings. For example, a first level of access may provide the data service provider with a capability to read (view) and modify the SOHO LAN monitor settings, while a second level of access may be lower than the first level and may provide the customer with a capability only to read (view) the SOHO LAN monitor settings. The SOHO LAN monitor settings may include, for example, one or more of the following: a) a periodicity of testing connectivity to the hosts on the LAN; b) a periodicity of collection host configurations; c) a periodicity of testing WAN-side connectivity; d) a periodicity of running one or more performance tests; and e) a periodicity of confirming nominal operation of one or more applications.

The periodic connectivity testing (either LAN-side or WAN-side) may be performed, for example, by way of “pinging.” Ping is a basic diagnostic program that provides for verification of connectivity to IP addresses. The host configuration information collected periodically may include, for example, work groups, host names, host access control settings, and other configuration information at the hosts. The periodic performance tests may test, for example, the speed of data transfer within between different points in the LAN or other performance characteristics. Finally, the periodic confirmation of nominal operation may confirm, for example, that simple mail transfer protocol (SMTP) (a protocol used by electronic mail applications) is operational.

As mentioned above, the periodicity of the various monitoring tests described above may be settable (configurable), for example, by the data service provider. The periodicity of each monitoring tests may differ from the periodicities of the other monitoring tests. For example, in one embodiment, the connectivity tests may be set to run more frequently than the other tests.

In one embodiment, the access controller 214 may be configured to allow the data service provider to query the monitor system 208 to retrieve a set of monitored data from the monitored data storage 218. The monitored data retrieved may include one or more of the following: a) LAN-side connectivity data; b) configuration settings from the hosts on the LAN; c) WAN-side connectivity data; d) performance test results; and e) confirmation of nominal operation of one or more applications.

As mentioned above, the connectivity testing (either LAN-side or WAN-side) may be performed, for example, by way of “pinging.” . The host configuration information collected may include, for example, work groups, host names, host access control settings, and other configuration information at the hosts. The performance test results may include, for example, the speed of data transfer within between different points in the LAN or other performance characteristics. Finally, the confirmation of nominal operation may confirm, for example, that simple mail transfer protocol (SMTP) (a protocol used by electronic mail applications) is operational.

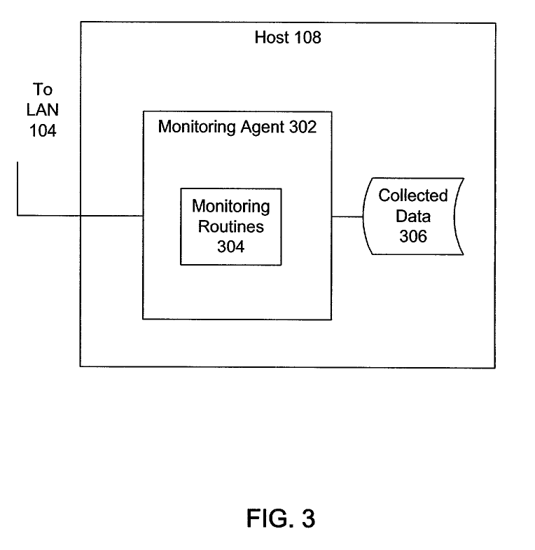

FIG. 3 is a diagram depicting a host device that is coupled to the LAN in accordance with an embodiment of the invention. The host device 108 may comprise, for example, computers and other networkable devices. Other networkable devices include networkable printers, networkable scanners, networkable faxes, and so on. As depicted in FIG. 3, the host device 108 may be configured to include a monitoring agent 302 in accordance with an embodiment of the invention. The monitoring agent 302 may comprise a small application that operates in cooperation with the SOHO LAN Monitor System 218 in the NAT device 208. The monitoring agent 302 may respond to queries from the Monitor System 218 with monitored data.

The monitoring agent 302 may run various monitoring routines 304 to collect the monitored data. Some monitoring routines 304 may be run in response to queries from the Monitoring System 218. Other monitoring routines 304 may be run autonomously by the monitoring agent 218, and the data collected from running the routines 304 may be returned in response to appropriate queries from the Monitoring System 218. The latter type of monitoring routines 304 would store the collected data 306 on the host 108.

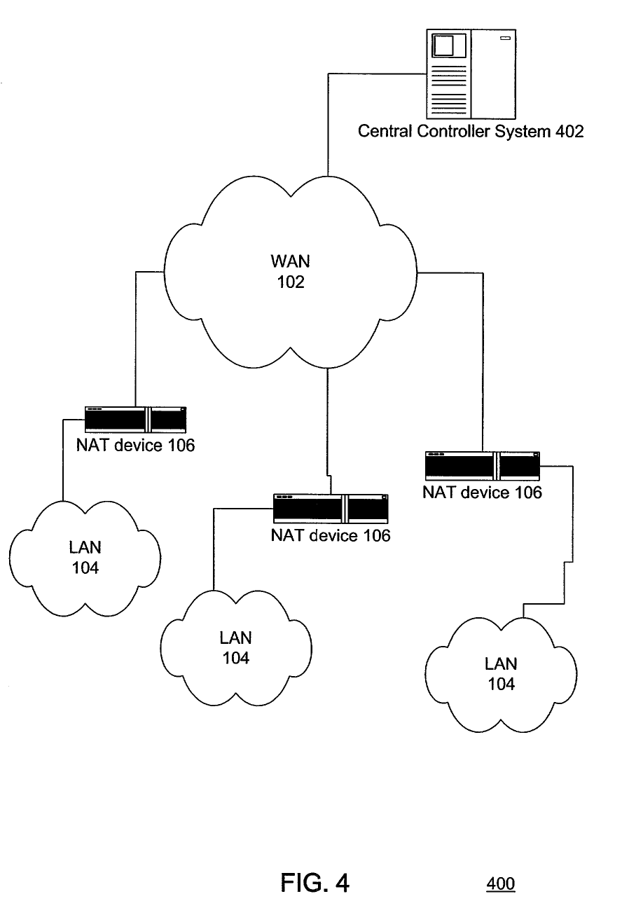

FIG. 4 is a diagram depicting a system for monitoring a plurality of LANs by way of NAT devices in accordance with an embodiment of the invention. The system 400 in FIG. 4 depicts a plurality of NAT devices 106. Each NAT device 106 is located between a LAN 104 and the WAN 102. Of course, each LAN 104 may interconnect multiple hosts 108 (not illustrated). The system 400 further comprises a central controller system 402 coupled to the WAN 102. In one embodiment of the invention, the central controller system 402 is configured to access and retrieve monitored data from the plurality of NAT devices 106. The central controller system 402 may be, for example, at a network operations center or customer support center of the data service provider that controls the WAN 102. The central controller system 402 may be configured to enable the data service provider to remotely monitor, and diagnose problems on, the customer LANs.

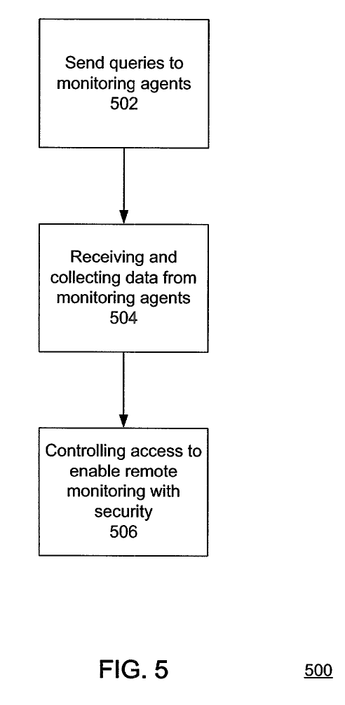

FIG. 5 is a flow chart depicting a method for remotely monitoring a LAN in accordance with an embodiment of the invention. In one embodiment, the method 500 may be performed by a monitor system 208 on a NAT device 106 in cooperation with monitoring agents 302 at hosts 108 on the LAN. The method 500 depicted in FIG. 5 includes three steps (502, 504, and 506).

In the first step 502, queries are sent from the monitor system 208 to monitoring agents 302 in hosts 108 on the LAN. These queries may relate to various network monitoring functions. For example, the queries may relate to one or more of the following: a) LAN-side connectivity data 602; b) configuration settings from the hosts on the LAN 604; c) WAN-side connectivity data 606; d) performance test results 608; and e) confirmation of nominal operation of one or more applications 610.

In the second step 504, the monitoring agents 302 generate responses to the queries. Some queries result in the monitoring agents 302 returning collected data 306. Other queries may result in the monitoring agents 302 running a monitoring test so that it may determine and collect data requested by the query.

In the third step 506, the responsive data is received by the monitor system 208 from the monitoring agents 302. The monitor system 208 may also store the data in monitored data storage 208 on the NAT device 106.

In the fourth step 508, remote access to the monitored data 208 may be provided to a data service provider. The remote access to the monitored data 208 should be provided securely via the WAN 102 such that access is limited to the data service provider or other designated entity.

FIG. 6 is a diagram depicting contents of monitored data storage in the NAT device in accordance with an embodiment of the invention. As shown in FIG. 6, the monitored data storage 218 may include various monitored content.

The monitored content may include, for example, a) LAN-side connectivity data, b) host configuration settings, c) WAN-side connectivity data, d) performance test results, and e) application operation confirmation data. As mentioned above, the connectivity data (either LAN-side or WAN-side) may include results from pinging IP addresses. The host configuration settings may include, for example, work groups, host names, host access control settings, and other configuration information at the hosts. The performance test results may include, for example, the speed of data transfer within between different points in the LAN or other performance characteristics. Finally, the application operation confirmation data may periodically verify that an application is working, for example, by checking that SMTP is functioning properly for an electronic mail application.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A network address translation enabled router device (NAT device) for separating a small office/home office local area network (SOHO LAN) from a wide area network (WAN), the NAT device comprising a SOHO LAN monitor system, wherein the SOHO LAN monitor system includes a query engine for sending queries to monitoring agents in hosts on the LAN, a data collection engine for receiving and collecting monitored data from the monitoring agents, and an access controller for controlling access to the SOHO LAN monitor system on the NAT device.

2. The NAT device of claim 1, wherein the SOHO LAN monitor system is accessible by way of a specific port, and wherein the specific port is assigned by static association.

3. The NAT device of claim 2, wherein the specific port comprises a layer 4 protocol port.

4. The NAT device of claim 1, wherein the access controller is configured for joint access both by a first party by way of the LAN and by a second party by way of the WAN.

5. The NAT device of claim 4, wherein the first party comprises a customer that uses the LAN, and the second party comprises a data service provider.

6. The NAT device of claim 5, wherein the access controller is configured to have multiple levels of access to a set of SOHO LAN monitor settings.

7. The NAT device of claim 6, wherein a first level of access provides the data service provider with a capability to modify the SOHO LAN monitor settings.

8. The NAT device of claim 7, wherein a second level of access provides the customer with a capability to only view the SOHO LAN monitor settings, and wherein the second level of access is lower than the first level of access.

9. The NAT device of claim 5, wherein the set of SOHO LAN monitor settings comprises a periodicity of testing connectivity to the hosts on the LAN and a periodicity of collecting host configurations.

10. The NAT device of claim 9, wherein the set of SOHO LAN monitor settings further comprises a periodicity of testing WAN-side connectivity.

11. The NAT device of claim 10, wherein the set of SOHO LAN monitor settings further comprises a periodicity of running a performance test.

12. The NAT device of claim 11, wherein the set of SOHO LAN monitor settings further comprises a periodicity of confirming nominal operation of an application.

13. The NAT device of claim 5, wherein the access controller is configured to enable the data service provider to query the SOHO LAN monitor system to retrieve a set of monitored data.

14. The NAT device of claim 13, wherein the set of monitored data retrieved comprises LAN-side connectivity data and configuration settings from the hosts on the LAN.

15. The NAT device of claim 14, wherein the set of monitored data retrieved further comprises WAN-side connectivity data.

16. The NAT device of claim 15, wherein the set of monitored data retrieved further comprises performance test results.

17. The NAT device of claim 16, wherein the set of monitored data retrieved further comprises confirmation of nominal operation of applications.

18. The NAT device of claim 1, wherein the NAT device further comprises:
a remotely-initiated diagnostic application to diagnose a problem on the LAN.

19. A system for monitoring a plurality of local area networks (LANs) by way of network address translation enabled router devices (NAT devices) between the LANs and a wide area network (WAN), the system comprising:
monitoring agents for hosts on each of the LANs;
a plurality of NAT devices, wherein each NAT device is located between a LAN and the WAN, and wherein each NAT device includes a query engine for sending queries to the monitoring agents on the corresponding LAN, a data collection engine for receiving and collecting monitored data from the monitoring agents on the corresponding LAN, and an access controller for controlling access to the NAT device; and
a central controller system coupled to the WAN for accessing and retrieving the monitored data from the plurality of NAT devices.

20. A method for remotely monitoring a local area network (LAN) by way of a monitor system on a network address translation (NAT) device, the method comprising:
sending queries to monitoring agents in hosts on the LAN;
receiving data returned from the monitoring agents; and
providing secure remote access by a data service provider to the monitor system.

21. The method of claim 20, wherein the data returned from the monitoring agents comprises LAN-side connectivity data.

22. The method of claim 20, wherein the data returned from the monitoring agents further comprises configuration settings from the hosts on the LAN.

23. The method of claim 20, wherein the data returned from the monitoring agents further comprises WAN-side connectivity data.

24. The method of claim 20, wherein the data returned from the monitoring agents further comprises performance test results.

25. The method of claim 20, wherein the data returned from the monitoring agents further comprises confirmation of nominal operation of applications.

26. A network address translation enabled router device (NAT device) for separating a local area network (LAN) from a wide area network (WAN), the NAT device comprising a LAN monitor system, wherein the LAN monitor system includes a query engine for sending queries to monitoring agents in hosts on the LAN, a data collection engine for receiving and collecting monitored data from the monitoring agents, and an access controller for controlling access to the LAN monitor system on the NAT device, wherein the LAN monitor system is accessible by way of a specific port, and wherein the specific port is assigned by static association, and wherein the specific port comprises a layer 4 protocol port.

27. A network address translation enabled router device (NAT device) for separating a local area network (LAN) from a wide area network (WAN), the NAT device comprising a LAN monitor system, wherein the LAN monitor system includes a query engine for sending queries to monitoring agents in hosts on the LAN, a data collection engine for receiving and collecting monitored data from the monitoring agents, and an access controller for controlling access to the LAN monitor system on the NAT device, wherein the access controller is configured for joint access both by a first party by way of the LAN and by a second party by way of the WAN, wherein the first party comprises a customer that uses the LAN, and the second party comprises a data service provider, wherein the access controller is configured to enable the data service provider to query the SOHO LAN monitor to retrieve a set of monitored data, and wherein the set of monitored data retrieved comprises LAN-side connectivity data and configuration settings from the hosts on the LAN.
